(19) United States
(12) Patent Application Publication
(10) Pub. No.: US 2015/0312287 A1
(43) Pub. Date: Oct. 29, 2015

(54) Compacting Content in a Desktop Sharing Session

(71) Applicant: CISCO TECHNOLOGY, INC., SAN JOSE, CA (US)

(72) Inventors: Huahua Yin, Suzhou (CN); Qi Shi, Suzhou (CN); Yi Lu, Suzhou (CN); Hua Ouyang, Suzhou (CN); Yunwei Luo, Suzhou (CN)

(73) Assignee: CISCO TECHNOLOGY, INC., SAN JOSE, CA (US)

(21) Appl. No.: 14/264,421

(22) Filed: Apr. 29, 2014

(51) Int. Cl. H04L 29/06; H04L 29/08

(52) U.S. Cl. CPC H04L 65/403; H04L 69/04; H04L 67/10

(57) ABSTRACT

Techniques to enable an attendee device in an online conference session to view display content different from display content displayed on a host device. In one embodiment a method is provided in which display content that is to be shared with at least one attendee device in an online conference session is captured from a host device. An area containing blank space in the display content is identified. The display content is compacted by removing the area containing the blank space from the display content to obtain compacted content. The compacted content is composed to obtain a composed image configured to be shared with the attendee device, and the composed image is thereafter shared with the attendee device.

### TECHNICAL FIELD

The present disclosure relates to sharing of content in an online conference session.

### BACKGROUND

In online/web-based meetings involving desktop sharing, documents or materials displayed on a presenter's or host's device can be shared with a plurality of meeting attendees by simultaneously displaying the same materials on the attendees' devices. With increasing diversity of devices used to participate in online meetings, a larger disparity in display size and resolution needs to be supported. Users with mobile devices with small displays may encounter a poor user experience when viewing the shared content of a user with a larger display.

### BRIEF DESCRIPTION OF THE DRAWINGS

FIG. 1A is a block diagram of an online conference system capable of supporting an online/web-based conference session during which content may be shared according to an example embodiment.

FIG. 1B is a block diagram of a user/attendee device or host device capable of participating in the online conference session according to an example embodiment.

FIG. 1C is a block diagram of a meeting server, including image compacting logic, capable of supporting an online conference session according to an example embodiment.

FIG. 2A is a simulated example screenshot from a display of a host device prior to application of the techniques described herein, according to an example embodiment.

FIG. 2B is a simulated example screenshot of the same content being displayed on the host device as depicted in FIG. 2A as that content would be seen on a mobile attendee device having a smaller display, according to an example embodiment.

FIG. 3 is a simulated screenshot of a display of the host device including identification of margins or locations of blank space within the content displayed on the host device, according to an example embodiment.

FIG. 4 is a flowchart showing one example of operations performed at a server to identify and trim or remove blank space in the content to be shared from a host device, according to an example embodiment.

FIGS. 5A and 5B are, respectively, displayed content before blank space is removed, and displayed content after blank space has been removed according to an example embodiment.

FIG. 6 shows how different versions of content displayed on the host device can be supplied to attendee devices having different display screen sizes, according to an example embodiment.

FIG. 7 shows an example table or database maintained by a server that indicates whether to send compacted or non-compacted content to a given attendee device, according to an example embodiment.

FIG. 8 is a flowchart showing one example of operations to supply different versions of content to different attendee devices, according to an example embodiment.

### DESCRIPTION OF EXAMPLE EMBODIMENTS

### Overview

Presented herein are techniques to enable an attendee device in an online conference session to view display content different from display content displayed on a host device. In one embodiment a method is provided in which display content that is to be shared with at least one attendee device in an online conference session is captured from a host device. An area containing blank space in the display content is identified. The display content is compacted by removing the area containing the blank space from the display content to obtain compacted content. The compacted content is composed to obtain a composed image configured to be shared with the attendee device, and the composed image is thereafter shared with the attendee device.

An apparatus is also disclosed. The apparatus includes a network interface configured to enable network communications with a host device and an attendee device via an electronic network, a memory configured to store image compacting logic, and a processor, responsive to the image compacting logic, configured to: capture, from the host device, display content that is to be shared with the attendee device in an online conference session, identify in the display content an area containing blank space, compact the display content by removing the area containing the blank space from the display content to obtain compacted content, compose the compacted content to obtain a composed image configured to be shared with the attendee device; and share the composed image with the attendee device.

### Example Embodiments

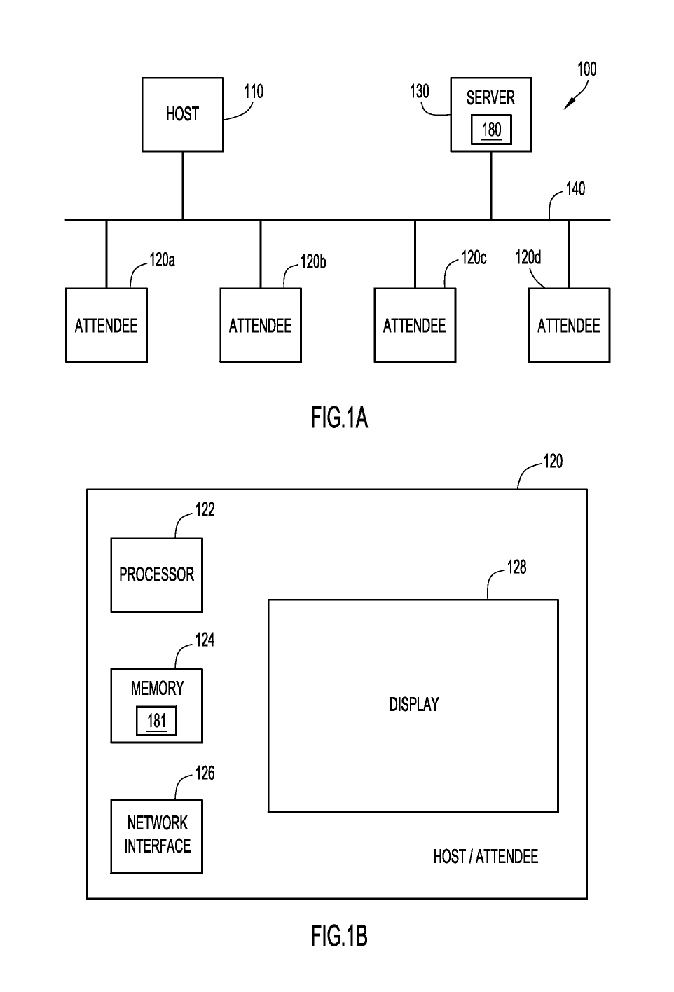

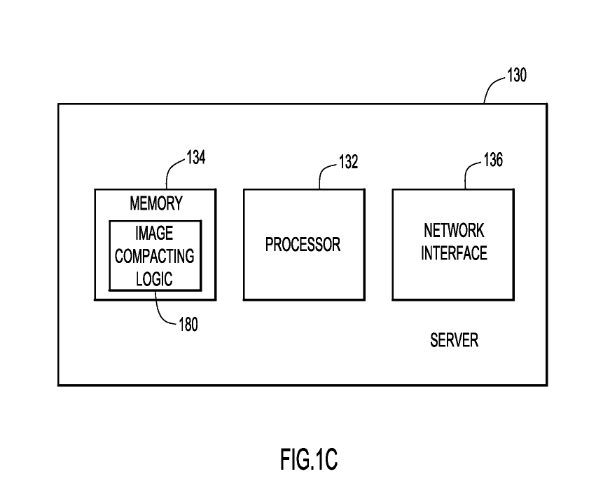

Referring to FIG. 1A, an online conference system 100 is shown that enables host device 110 to share documents and information with attendee devices 120a-120d through meeting server 130 across network 140. Only four attendee devices are shown in FIG. 1, but those skilled in the art will appreciate that any number of attendee devices may be included in system 100. Host device 110 and attendee devices 120a-120d may take a variety of forms, including a desktop computer, laptop computer, mobile/cellular phone, tablet computer, etc. Network 140 may be any type of network (e.g., any combination of Internet, intranet, local area network (LAN), wide area network (WAN), wired network, wireless network, etc.) that connects computing devices, e.g., host device 110 and attendee devices 120a-120d. Meeting server 130 may be used, for example, to mediate transactions between host device 110 and attendee devices 120a-120d. Server 130 may also perform caching or other time/bandwidth saving techniques. It should be understood that in a web-based conference system, each device may communicate with the server 130 through a browser application having one or more plug-ins that enable web-based meeting, and allow for the transmission of data to the meeting server 130, and the reception of data from the meeting server during a conference/meeting session. As will be explained later herein, server 130 may be configured to perform “compacting” operations on content that is displayed on host device 110 so that a given attendee device that has a smaller screen can more easily participate in the conference session. The compacting operations may operate in accordance with image compacting logic 180 that is stored and/or is caused to operate on server 130.

Referring to FIG. 1B, a simplified block diagram of an example device, e.g., host device or attendee device is shown. For simplicity, FIG. 1B shows a block diagram of one of the attendee devices 120a-120d, generically referred to or labeled with reference numeral 120. The device includes a processor 122 to process instructions relevant to a conference/meeting session supported by the system 100, memory 124 to store a variety of data and software instructions (e.g., display data for shared documents, applications, as well software instructions for a browser application to enable the connectivity and display of data during a conference session, compacting indication logic 181, etc.). The device also includes a network interface unit (e.g., a network interface card (NIC)) 126 to communicate with other devices over network 140, and a display 128 to display a user interface (e.g., a desktop with windows) and other data associated with functions of the device as well as user interface items associated with the conference session (by way of software for a browser application stored in memory 124). The attendee device may also include other user interface units in the form of a keyboard, mouse and/or a touchscreen user interface (integrated with display 128) to allow for a user of the attendee device to interface with the device. Memory 124 may comprise read only memory (ROM), random access memory (RAM), magnetic disk storage media devices, optical storage media devices, flash memory devices, electrical, optical, or other physical/tangible (e.g., non-transitory) memory storage devices. The processor 122 is, for example, a microprocessor or microcontroller that executes instructions for implementing the processes described herein. Thus, in general, the memory 124 may comprise one or more tangible (non-transitory) computer readable storage media (e.g., a memory device) encoded with software comprising computer executable instructions and when the software is executed (by the processor 122) it is operable to perform the operations described herein. While attendee device 120 and host device 110 will be described as different devices, they differ only in their respective roles in the conference session. In general, a user device that can be configured to be an attendee device 120 may also be configured to be a host device 110, at different times in the same or different conference sessions.

Referring now to FIG. 1C, a simplified block diagram of an example meeting server 130 is shown. Meeting server 130 includes a processor 132 to process instructions relevant to a conference/meeting session supported by the system 100, memory 134 to store a variety of data and software instructions (e.g., display data for shared documents, applications, as well software instructions for a browser application to enable the connectivity and display of data during a conference session, and image compacting logic 180, etc.). The device also includes a network interface unit (e.g., a NIC) 136 to communicate with other devices over network 140. Memory 134 may comprise read only memory (ROM), random access memory (RAM), magnetic disk storage media devices, optical storage media devices, flash memory devices, electrical, optical, or other physical/tangible (e.g., non-transitory) memory storage devices. The processor 132 is, for example, a microprocessor or microcontroller that executes instructions for implementing the processes described herein. Thus, in general, the memory 134 may comprise one or more tangible (non-transitory) computer readable storage media (e.g., a memory device) encoded with software comprising computer executable instructions and when the software is executed (by the processor 132) it is operable to perform the operations described herein.

As noted, remote desktop sharing is a popular feature in online web conferencing. A host device 110 shares its desktop content and remote attendees are configure to view the shared content via an attendee device 120 such as a personal computer, laptop, tablet or smartphone. Assuming the host device 110 and an attendee device 120 have substantially the same size display screen, what is displayed on a display of the host device is very easily viewable on a display of the attendee device.

On the other hand, where an attendee device 120 has a smaller display screen, e.g., when the attendee device 120 is a smartphone, a user's experience might be diminished since what may be easily seen on a larger screen (associated with the host device 110) might be more difficult to see on a smaller screen. One way for an attendee to address the problem of difficult-to-see content shared from a larger display is to (using, e.g., touch gestures) continually expand/magnify and/or move/manipulate the content being displayed on the smartphone in order to better view the content being shared. However, such operations may be, at the very least, distracting and or inconvenient to the attendee.

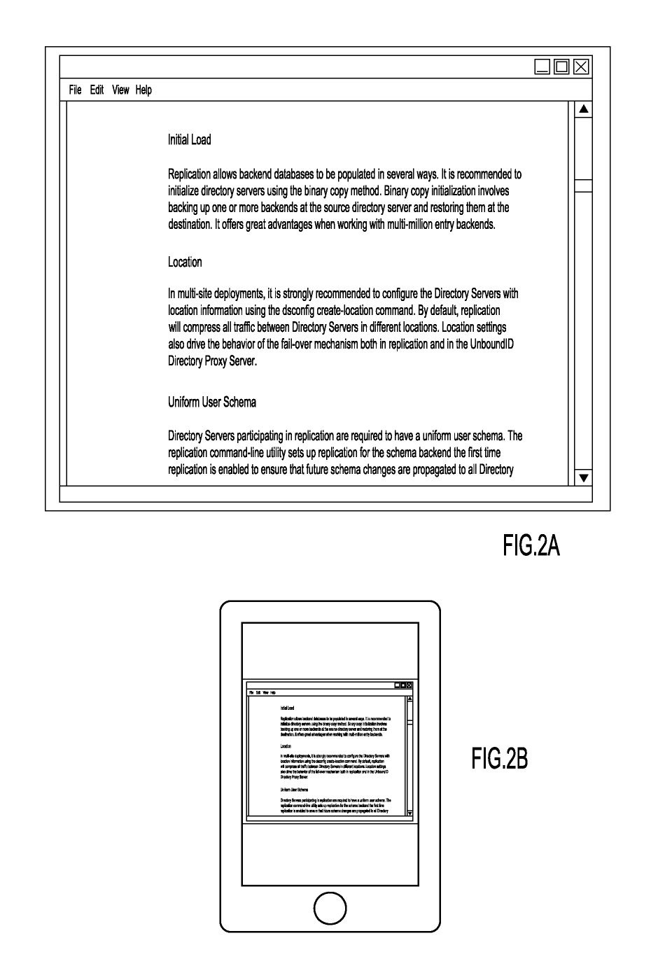

FIG. 2A is a simulated example screenshot from a display of host device 110 prior to application of the techniques described herein. FIG. 2B is a simulated example screenshot of the same content being displayed on host device 110 as that content would be seen on a mobile attendee device 120 having a smaller display. That is, in a conventional desktop sharing arrangement, the entirety of what is shown on the display (or a selected shared application) is shared and displayed on an attendee device. Notably, and as is readily apparent, for given content being displayed, it is more difficult to view that content on a smaller screen. That is, as a result of the orientation of the image displayed on the smaller screen, and most importantly the size of the screen, the image is substantially compressed. Specifically, the text size may be substantially smaller and thus substantially more difficult to read.

By inspecting the displayed content shown in FIG. 2A, however, it can be seen that there is a substantial amount of blank space that does not necessarily provide useful content to an attendee. The techniques described herein provide a mechanism by which the blank space or non-useful content is removed or trimmed from the image via particular processing techniques, and the resulting processed image is supplied to attendee devices that might have smaller display screens than the display screen of the host device.

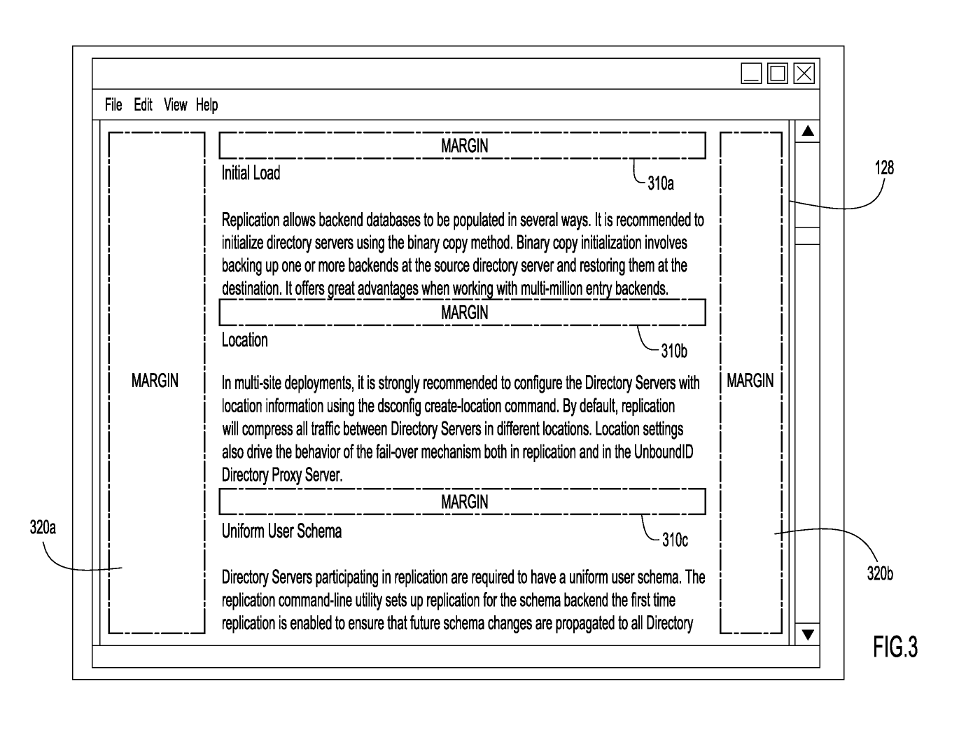

FIG. 3 is a simulated screenshot of a display of a host device 110 identifying margins or locations of blank space within the content displayed on the host device. As shown, several blank spaces are depicted. Specifically, three blank spaces 310a, 310b, 310c extend substantially horizontally across display 128 of host device 110. These blank spaces, also referred to as “margins,” extend between text paragraphs in the displayed content. Other blank spaces or margins extend substantially vertically. Specifically, two such blank spaces 320a, 320b may be present as a result of pre-set right/left margins of a page.

There are several of ways to determine whether margins or blank space is present in a given document. For example, it can be determined whether a given, e.g., background color extends in a given row (column) of the displayed content from one edge of the page to an opposite edge of the page. If a minimum number of contiguous rows (columns) having the same (e.g., background) color are detected, then it can be said that those rows (columns) should be considered blank space.

As a more specific example, it is possible to remove margins or blank spaces by utilizing image processing techniques such as blue screen (green screen) processing. For example, the background of a given image received from a host device can be filled with the color blue (or green). Using processing tools such as, e.g., ADOBE™ After Effects, it is possible to distinguish between blank spaces and text. Once the blank spaces/margins and content are distinguished from one another, it is then possible using, e.g., ADOBE™ After Effects, to rearrange the text portions to be closer to one another such that a compacted image or compacted content is generated. That is, it is possible to remove, delete or eliminate the blank space to achieve compacted content.

In sum, once one or more margins are detected, the margins can be deleted resulting in the remaining content being compacted or compressed so that more of the content can be viewed simultaneously on a smaller display of an attendee device.

In an embodiment, the content to be displayed is supplied from a host device to server 130 for processing. Image compacting logic 180 (which may comprise an image processing utility such as ADOBE™ After Effects) stored in memory 134 of server 130 might then be configured to process the image to generate a compacted version thereof by removing identified or designated blank space. The resulting compacted image can then be supplied to an attendee that is participating in the conference session using an attendee device that has a smaller screen than the host device, or, alternatively, because a given attendee simply prefers to receive the displayed content in a compacted format.

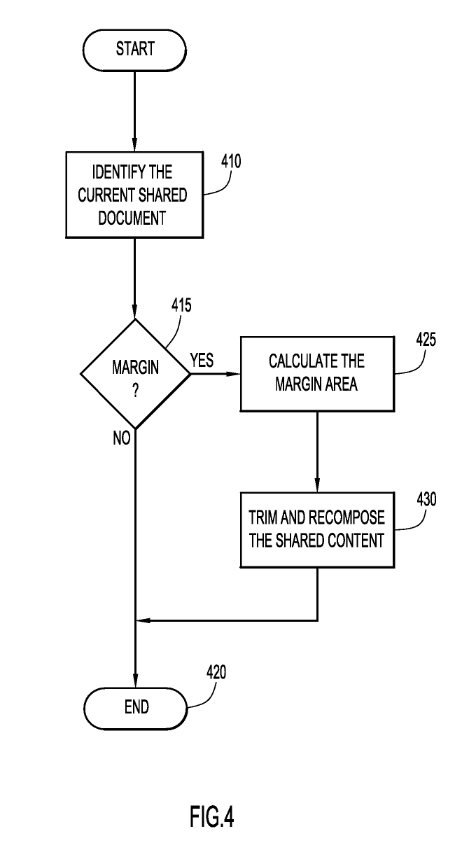

FIG. 4 is a flowchart showing one example of operations performed at server 130 to identify and trim or remove blank space in the content to be shared from a host device 110. As shown, the operations begin at 410 wherein a current shared document (e.g., a PDF file, Word processing document, graphics document, etc.) is identified. At 415, it is determined whether the document contains any blank space or margins that are candidates for elimination. If no such margins are detected, then at 420 the operations end. If at 415 it is determined that margins exist, then at 425 specific margin areas are calculated or designated for elimination or deletion. At 430, those designated margins are then trimmed or eliminated from the content, and the remaining content is compacted and/or re-composed. The operations then end at 420. Those skilled in the art will appreciate that operations 425 and 430 could be combined into a single operation.

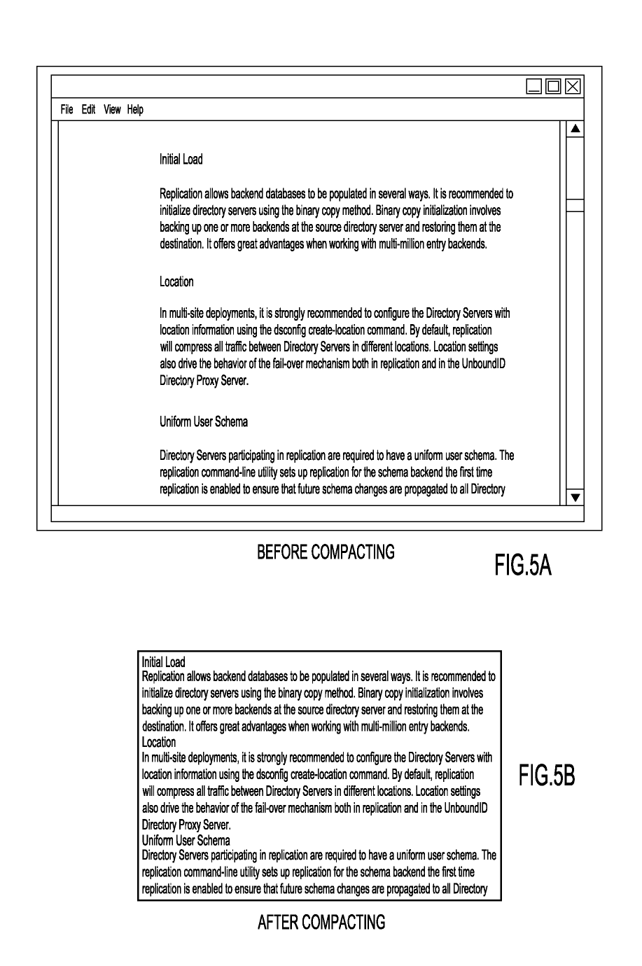

FIGS. 5A and 5B show, respectively, displayed content before blank space is removed, i.e., before compacting operations have been applied, and after blank space has been removed, i.e., after compacting operations have been applied, in accordance with the techniques described herein. As can be seen in FIG. 5B (compared to FIG. 5A), contiguous blank space has been deleted, such that individual sections of text (e.g., the several text paragraphs) are compacted together, i.e., such that they are arranged closer to one another.

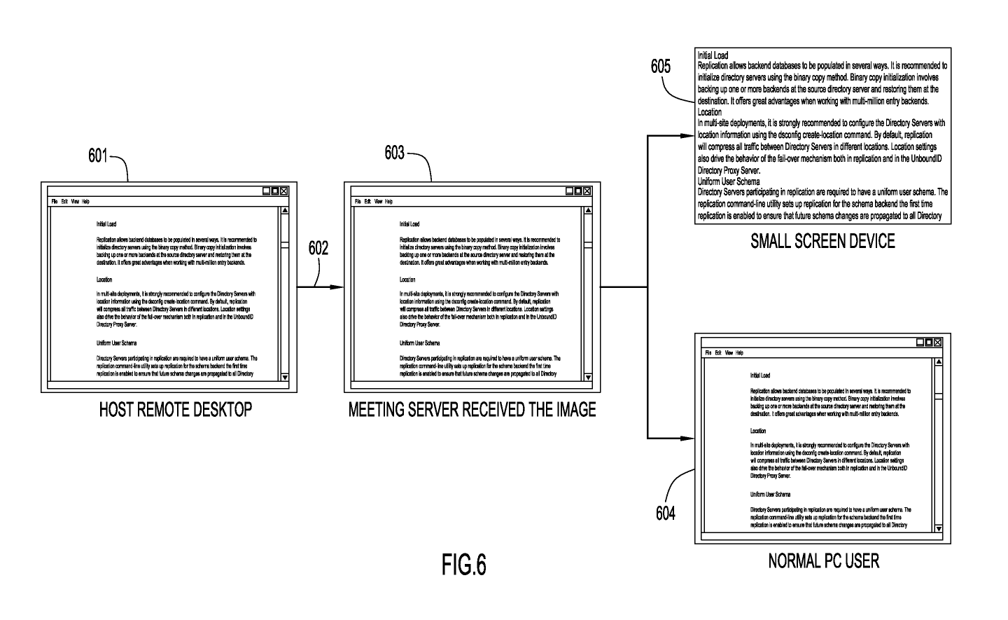

FIG. 6 shows how different versions of content displayed on a host device can be supplied to attendee devices having different screen sizes. More specifically, FIG. 6 shows the state of display content at various stages within the context of a conference session. The display content shown at 601 is the display content that is displayed on the display of a host device and is the original content generated or selected by a host to be shared with attendees. Content 601 is then transferred, at 602, to a meeting server (e.g., meeting server 130) where the content (now designated as 603) is still in the same form as content 601. The meeting server is then operable to supply at least two different types of content to selected attendees. In a first instance, the meeting server delivers or transmits to an attendee device content 604. Content 604 is in the same format as content 603 (which is equivalent to content 601). That is, the meeting server essentially passes the content received from the host device directly to an attendee device without any substantial processing or manipulation of the content. In other words, the attendee device will display what is being displayed on the host device. Such content may be considered to be non-compacted.

The meeting server is also operable, however, to perform compacting operations on content 603 to generate compacted content 605. Compacted content 605 is generated by, as explained above, removing or eliminating blank space or margins that can be considered to provide only limited or no information to an end user attendee. Consequently, compacted content 605 can provide an improved user experience for attendees using a smaller screen, such as that of a smartphone or tablet computer.

In one possible implementation, server 130 is configured to identify the type of device (smartphone, desktop, etc.) that a given attendee is using. This can be accomplished, for example, during a registration process for an online conference service that hosts the online conference. In another implementation, the attendee device can automatically identify itself as a device that would benefit from receipt of compacted content. Such identification might be in response to server 130 sending a query to the attendee device that is attempting to join the conference. An attendee might also manually notify server 130, via attendee device 120, that the attendee device being used would benefit from compacted content.

Either or both of the automatic or manual notification scenarios can be supported by image compacting indication logic 181 that is provided on attendee device 120. That is, in accordance with an embodiment, image compacting indication logic 181 is configured to provide a notification to server 130 that the attendee device is to receive compacted content. If a given attendee device is the first attendee device to make such a notification in a given online web conference, then server 130, and particularly image compacting logic 180, is configured to generate the compacted content for images that are being displayed on the host device 110. Non-compacted content can also be supplied to other attendee devices at the same time.

In one possible implementation, and one that may be particularly beneficial in the automatic notification scenario noted above, image compacting indication logic 181 may be configured to alert or notify an attendee that the content being displayed on the attendee device has been compacted. That is, it may not be immediately apparent to an attendee that the content being shared by host device 110 and that is being displayed on the attendee device has been compacted. As such, image compacting indication logic 181 can be configured to display an icon or some other indicia that indicates that the image being view comprises compacted content. Such indicia may also be added to the compacted content by image compacting logic 180 at server 130 and delivered to attendee device with the indicia already in place.

It is noted also that a given attendee might actually prefer not to receive compacted content. As such, image compacting indication logic 181 may further be configured to enable an attendee to notify server 130 (and, perhaps, also image compacting logic 180) that the attendee no longer desires the content to be compacted. In this case, an indication representative of the attendee's desire to receive non-compacted content is sent from attendee device 120 to server 130. In response, server 130 will no longer send compacted content to that attendee device.

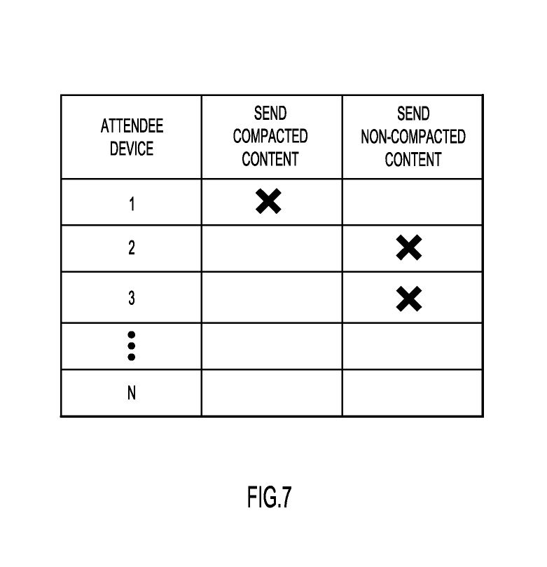

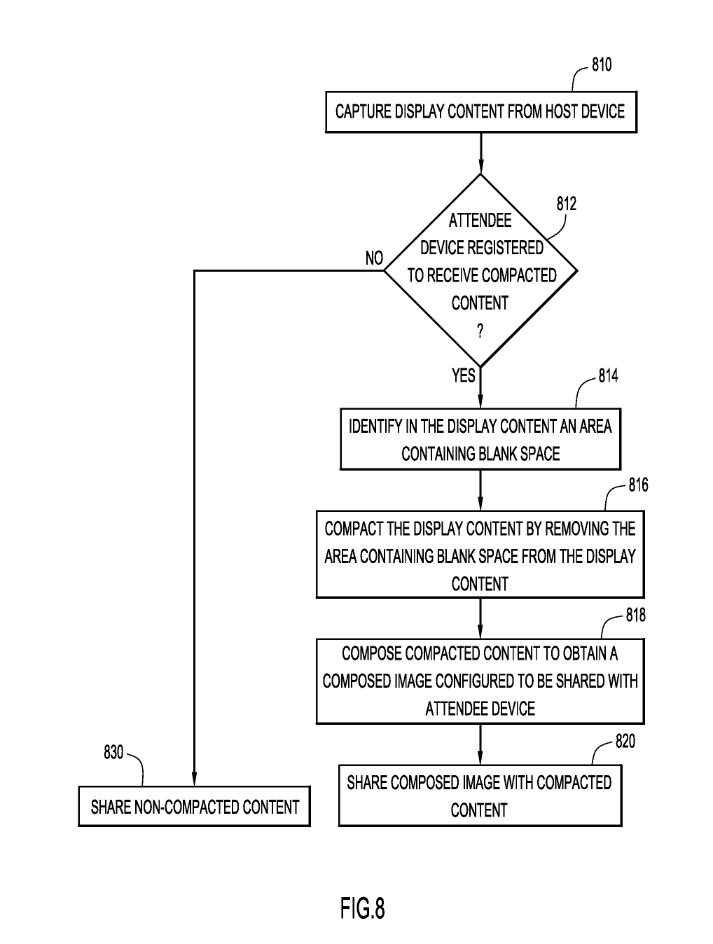

To manage which attendee devices are to receive compacted or non-compacted content, server 130 may maintain a table or database for each registered attendee device. Such a table is shown in FIG. 7 and includes for each attendee device registered for a given online conference session an indication as to whether compacted or non-compacted content is to be sent to that attendee device. Those skilled in the art will appreciate that the database shown in FIG. 7 is merely an example, and could be implemented as a two column database wherein one of the column indicates whether compacted content is to be delivered. If no indication is provided in that column, then the default state might be to send non-compacted content. The state of such a table or database would be changed based on whether a given attendee expressly requested or expressly rejected compacted content.

FIG. 8 is a flowchart showing one example of operations to supply different versions of content to different attendee devices. As indicated at 810 display content is captured from a host device in an online conference session. The display content is to be shared with at least one attendee device in an online conference session. At 812, it is determined whether there is an attendee device that is registered for the conference that is to receive compacted content. If no such attendee is registered, then operations proceed to 830 where non-compacted content is shared with an attendee device. Those skilled in the art will appreciate that operation 812 is optional and the methodology described herein could be configured to not include this operation.

If at 812, it is determined that there is an attendee device that is to be provided with compacted content, then at 814, an area containing blank space is identified in the display content. At 816, the display content is compacted by removing the area containing the blank space from the display content, resulting in compacted content. Of course, more than one area of blank space can be removed in the compacting process. At 818, the compacted content is composed to obtain a composed image configured to be shared with the attendee device that is to be provided with compacted content. At 820, the composed image with the compacted content is shared with the attendee device.

Thus, as will be appreciated, the methodology described herein is configured to selectively deliver compacted and non-compacted content to respective attendee devices, depending on, e.g., the size of the respective display screens associated with the attendee devices. Further, the methodology may be configured to receive a request from an attendee device indicative of a desire to receive the compacted content, and responsive to that request, a server may thereafter deliver such compacted content. Compacted content may be generated by, e.g., removing an area having a horizontally extending blank space or an area having a vertically extending blank spaced. Compacting the display content may, similarly, include removing blank space between sections of text in display content, or blank space extending along vertical margins of the display content.

Compacting of the content may still further include removing at least one of an application menu, status bar, or tool bar that is part of the display content. Typically such content does not add any useful information for the attendee, and may therefore be a candidate for removal to achieve a higher degree of content compaction.

To provide an attendee with a status regarding the type of content being delivered, the methodology may also be configured to generate and include as part of the compacted content a notification such as predetermined indicia indicative that blank space has been removed. Alternatively, image compacting indication logic, integrated with an attendee device, may be configured to provide a similar notification.

The methodology described herein has several advantages. For example, shared content (display content) can be compacted during (i.e., in near real-time) an online conference session. The methodology described herein also enables mobile users who are joining an online conference with a small screen attendee device to have an improved user experience. In addition, because the display content is compacted, less network bandwidth is used to send the shared content to a given attendee device.

In sum, a method according to one embodiment includes capturing or obtaining, from a host device, display content that is to be shared with at least one attendee device in an online conference session, identifying in the display content an area containing blank space, compacting the display content by removing the area containing the blank space from the display content to obtain compacted content, composing the compacted content to obtain a composed image configured to be shared with the attendee device, and sharing the composed image with the attendee device.

An embodiment may further include performing the method in response to determining that a display screen employed at the attendee device has a smaller size than a display screen employed by the device and/or receiving a request from the attendee device indicative of a desire to receive the compacted content.

Compacting the display content may include removing an area having a horizontally extending blank space or an area having a vertically extending blank spaced, removing the blank space between sections of text, or removing the blank space extending along vertical margins of the display content. Compacting the display content may still further include removing at least one of an application menu, status bar, or tool bar that is part of the display content.

In accordance with one possible implementation, the methodology may include generating and including as part of the compacted content indicia indicative that the blank space has been removed.

The methodology may also include simultaneously sharing a non-compacted version of the display content with another attendee device.

The above description is intended by way of example only. Various modifications and structural changes may be made therein without departing from the scope of the concepts described herein and within the scope and range of equivalents of the claims.

What is claimed is:

1. A computer-implemented method comprising:
capturing, from a host device, display content that is to be shared with at least one attendee device in an online conference session;
identifying in the display content an area containing blank space;
compacting the display content by removing the area containing the blank space from the display content to obtain compacted content;
composing the compacted content to obtain a composed image configured to be shared with the attendee device; and
sharing the composed image with the attendee device.

2. The method of claim 1, further comprising performing the method in response to determining that a display screen employed at the attendee device has a smaller size than a display screen employed by the device.

3. The method of claim 1, further comprising receiving a request from the attendee device indicative of a desire to receive the compacted content.

4. The method of claim 1, wherein compacting the display content comprises removing an area having a horizontally extending blank space or an area having a vertically extending blank spaced.

5. The method of claim 1, wherein compacting the display content comprises removing the blank space between sections of text.

6. The method of claim 1, wherein compacting the display content comprises removing the blank space extending along vertical margins of the display content.

7. The method of claim 1, further comprising removing at least one of an application menu, status bar, or tool bar that is part of the display content.

8. The method of claim 1, further comprising generating and including as part of the compacted content indicia indicative that the blank space has been removed.

9. The method of claim 1, further comprising simultaneously sharing a non-compacted version of the display content with another attendee device.

10. The method of claim 1, wherein composing is performed at a server computer that is communicatively coupled to the host device and to the attendee device.

11. An apparatus comprising:
a network interface unit configured to enable network communications with a host device and an attendee device via a network;
a processor configured to:
obtain, from the host device, display content that is to be shared with the attendee device in an online conference session;
identify in the display content an area containing blank space;
compact the display content by removing the area containing the blank space from the display content to obtain compacted content;
compose the compacted content to obtain a composed image configured to be shared with the attendee device; and
cause the composed image to be sent via the network interface unit so that it can be shared with the attendee device.

12. The apparatus of claim 11, wherein the processor is further configured to:
compact the display content in response to determining that a display screen employed at the attendee device has a smaller size than a display screen employed by the device.

13. The apparatus of claim 11, wherein the processor is further configured to:
receive a request from the attendee device indicative of a desire to receive the compacted content.

14. The apparatus of claim 11, wherein the processor is further configured to:
remove an area having a horizontally extending blank space or an area having a vertically extending blank spaced.

15. The apparatus of claim 11, wherein the processor is further configured to:
remove the blank space between sections of text.

16. The apparatus of claim 11, wherein the processor is further configured to:
remove at least one of an application menu, status bar, or tool bar that is part of the display content.

17. The apparatus of claim 11, wherein the processor is further configured to:
cause to be generated and included as part of the compacted content indicia indicative that the blank space has been removed.

18. One or more computer readable storage media encoded with software comprising computer executable instructions that, when executed, are operable to:
obtain, from a host device, display content that is to be shared with an attendee device in an online conference session;
identify in the display content an area containing blank space;
compact the display content by removing the area containing the blank space from the display content to obtain compacted content;
compose the compacted content to obtain a composed image configured to be shared with the attendee device; and
cause the composed image to be sent over a network to be shared with the attendee device.

19. The computer readable storage media of claim 18, wherein the instructions, when executed, are further operable to:
compact the display content in response to determining that a display screen employed at the attendee device has a smaller size than a display screen employed by the device.

20. The computer readable storage media of claim 18, wherein the instructions, when executed, are further operable to:
receive a request from the attendee device indicative of a desire to receive the compacted content.
